(19) United States
(12) Patent Application Publication
(10) Pub. No.: US 2010/0321572 A1
(43) Pub. Date: Dec. 23, 2010

(54) SYSTEM AND METHOD FOR IMAGE STABILIZATION

(75) Inventors: Alan Cornett, Andover, MN (US); Robert C. Becker, Eden Praire, MN (US); Andrew H. Johnson, New Brighton, MN (US); Robert E. De Mers, Nowthen, MN (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/487,329

(22) Filed: Jun. 18, 2009

(51) Int. Cl. H04N 7/00; G08B 21/00; H04N 9/12; G06F 15/00

(52) U.S. Cl. 348/552; 340/669; 702/141; 348/E05.062; 348/739

(57) ABSTRACT

A system includes a first accelerometer and a second accelerometer that are coupled to a processor. The processor is configured to receive input from the accelerometers, calculate a displacement of the first accelerometer and a displacement of the second accelerometer, and refresh a video display unit as a function of the displacement of the first accelerometer and the displacement of the second accelerometer.

### TECHNICAL FIELD

The present disclosure relates to video displays in vehicles, and in an embodiment, but not by way of limitation, a system and method for image stabilization in video displays in vehicles.

### BACKGROUND

Vehicles today, including land-based vehicles, watercraft, and aircraft, normally have one or more video display units within them. These video display units can be for the primary benefit of an operator of the vehicle, and can include instruments that report on the function and status of the vehicle. These video display units can also be for the primary benefit of a passenger in the vehicle, and can include displays for entertainment purposes such as a DVD display unit in a van. While the readability of these display units is not a problem under ordinary operational situations, the readability of these display units can become impaired when the vehicle experiences jostling from a rough road, choppy waters, or air turbulence.

### BRIEF DESCRIPTION OF THE FIGURES

FIG. 1 illustrates a land-based vehicle on a rough road according to an example embodiment.

FIG. 2 illustrates a field of view of a person in a vehicle according to an example embodiment.

FIG. 3 illustrates a placement of accelerometers in a vehicle according to an example embodiment.

FIG. 4 illustrates a response of a vehicle going over a bump in a road according to an example embodiment.

FIG. 5 illustrates a response of a vehicle and passenger going over a bump in the road according to an example embodiment.

FIG. 6 illustrates a displacement of a person in a vehicle relative to the vehicle when driving over a bump in the road according to an example embodiment.

FIG. 7 is a flowchart of an example embodiment of a process to display an image on a display unit in a vehicle as a function of the displacement of the vehicle and the displacement of the person.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

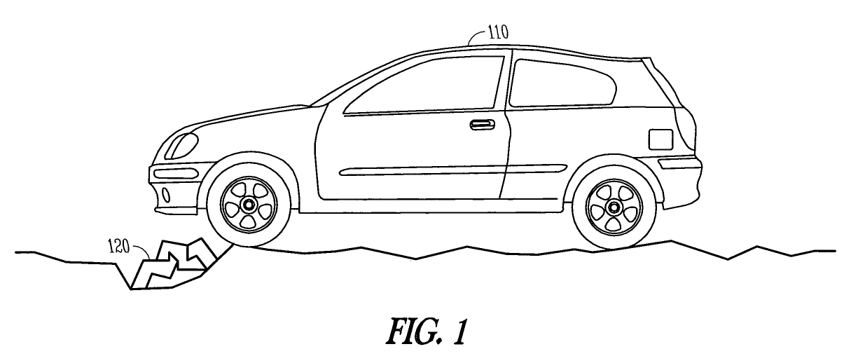

FIG. 1 illustrates a vehicle 110 that is about to run over an obstacle 120 in a road. When the vehicle 110 comes into contact with and runs over the obstacle 120, the vehicle and the passengers in the vehicle will be displaced in a vertical direction. This vertical displacement can make it difficult to view a display unit, such as an instrument panel or a video display unit. An embodiment of the present disclosure addresses this situation by calculating a relative displacement between the vehicle and a passenger in the vehicle, and redisplaying the image on the display unit as a function of the relative displacement of the vehicle and the passenger. While in connection with the present disclosure a land-based vehicle is discussed, those of skill in the art will realize that the embodiments disclosed herein can be applied to other vehicles such as watercraft and aircraft.

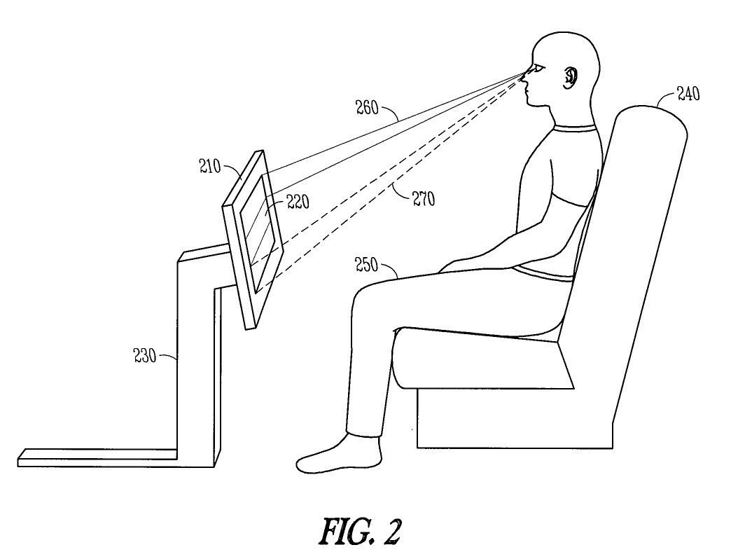

FIG. 2 illustrates the manner in which a passenger's field of view of a display unit can change when a vehicle experiences rough terrain. Specifically, FIG. 2 illustrates a passenger 250 in a vehicle seat 240. A display unit 210, including a display screen 220, is mounted on the vehicle frame 230. In a normal situation, the focus of a passenger's field of view is identified by 260. However, when a vehicle comes in contact with and runs over an obstacle in the road, the vehicle and the passenger are displaced vertically. However, the vertical displacement of the passenger is not as great as the vertical displacement of the vehicle since the passenger will “sink into” the vehicle seat when the vehicle encounters and runs over an obstacle. The result is that after hitting the obstacle, the passenger's field of view will change to 270. This change in the field of view makes reading the display screen 220 difficult.

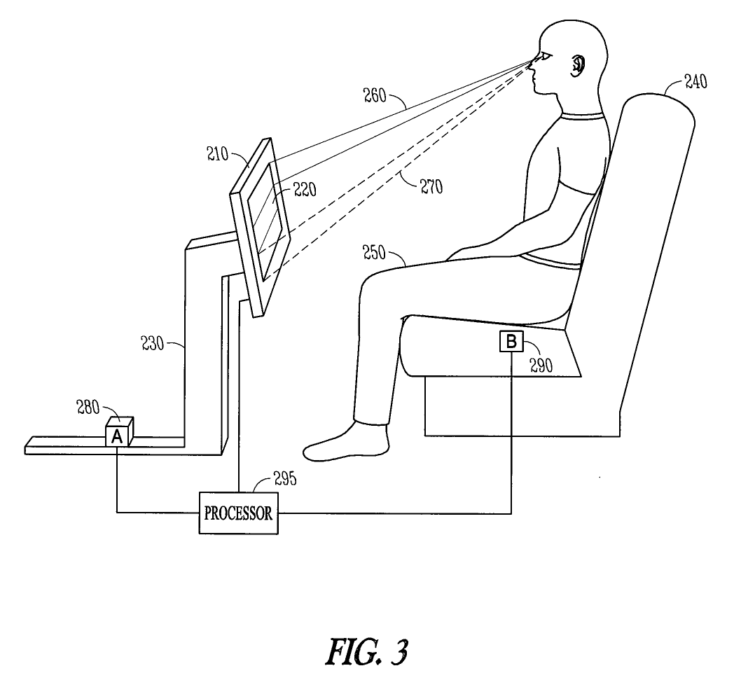

FIG. 3 illustrates an embodiment that addresses the problem of a change in a passenger's field of view when that passenger is jostled during a ride on a rough road. Specifically, FIG. 3 illustrates an accelerometer 280 placed on the vehicle, and an accelerometer 290 placed in a passenger's seat. The accelerometers 280 and 290 are coupled to a processor 295, which can receive data from the accelerometers and perform calculations using that data. The processor 295 can also be coupled to the display unit 210. The accelerometer 280 can be placed on the vehicle frame 230. The accelerometer 290 can also be configured to be placed on the passenger, such as by equipping the accelerometer 290 with a strap or a clip. The accelerometer 280 measures the displacement of the vehicle, and the accelerometer 290 measures the displacement of the passenger. The difference in relative displacement of the vehicle and the passenger can then be used to address the problem of viewing the screen display 220 upon encountering and running over an obstacle in the road. As one of skill in the art would readily realize, the accelerometers 280 and 290 must be oriented along the same axis, so that both accelerometers measure a substantially vertical displacement or a substantially horizontal displacement.

The functionality of the system of FIG. 3 is based on the following. The basic motion equation of a displacing force on an object is

F=−k*x; (1)

where F=force, k=restoring force coefficient, and x=displacement. The force portion of this equation can be written as:

F=m*a; (2)

where m=object mass and a=acceleration. Equation (2) can be rewritten in terms of displacement as:

F=m*d²x/dt². (3)

Equations (2) and (3) can be combined to arrive at the following:

m*d²x/dt²=−k*x. (4)

Equation (4) describes a simple oscillator. In order to complete equation (4), friction losses should be included. To a first order approximation, friction losses can be estimated as linearly proportional to object velocity. In this case, the motion equation becomes:

m*d²x/dt²+b*dx/dt+k*x=0; (5)

where b is the friction loss. This represents a system free of external influences. If there are external influences, such as external forces, equation (5) becomes:

m*d²x/dt²+b*dx/dt+k*x=F(t); (6)

where F(t) represents a time varying external force applied to the system. A general solution to equation (6) is in the form of

X=X₀+sin(ω*t)*e^{-at};

where t=time, X₀=initial displacement,

$$ω = \sqrt{( \frac{k}{m} - {( \frac{b}{2 m} )}^{2} )} , \qquad ( 7 )$$

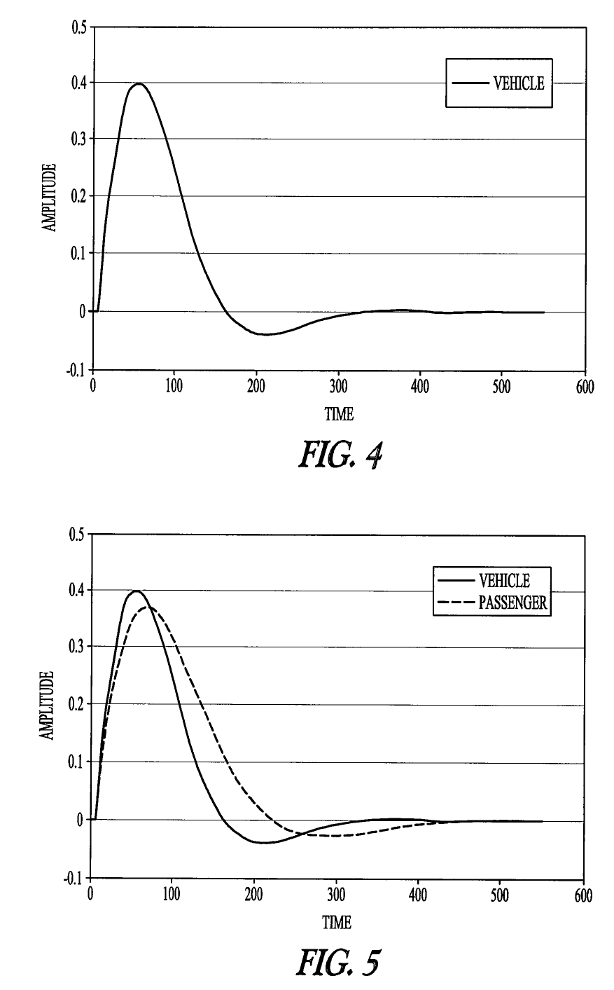

and α=(b/2m). Equation (7) is an equation of a damped sinusoid. FIG. 4 illustrates the response of a step increment in an external applied force, such as would result from driving over an object. The vehicle would be displaced upward initially, and then overshoot the equilibrium position before returning to equilibrium later after passing over the object.

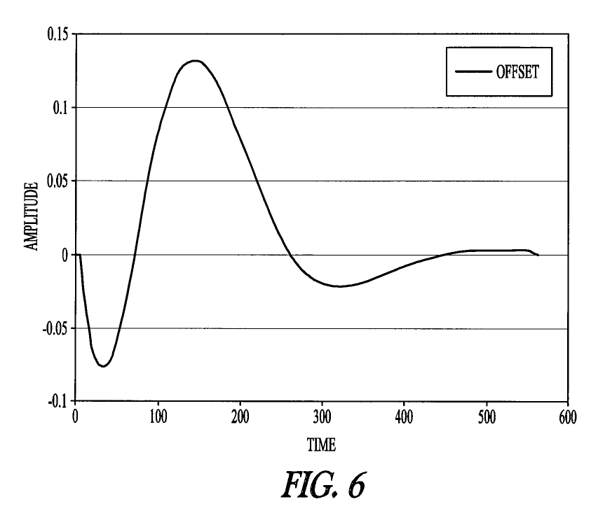

The basic formula of equation (7) can be used to calculate the effects of vehicle motion on a passenger. A passenger in the seat of a vehicle would experience a force related to the displacement of the vehicle from equilibrium. In this case, this would resemble FIG. 5. The position of the passenger relative to the vehicle is what is really of interest, as the change in the passenger's position relative to the vehicle is what causes the apparent jumping of screen images that makes the images so hard to read in a vehicle moving over rough terrain. That is shown in FIG. 6. FIG. 6 illustrates how that initially, the passenger sinks into his seat, rises up sharply past equilibrium into a broad peak, sinks back into the seat below equilibrium before beginning to settle back to equilibrium. It is the initial two large displacements that make reading a display unit so difficult due to the large relative shift in focus of the passenger.

By placing one or more accelerometers 290 in the passenger seat, this displacement can be directly measured as a function of time using the above equations. Once the displacement is known, the displayed data or image can be compensated to stabilize the image. Small displacements may or may not be compensated for because they do not cause a loss of focus on the display. An example of this could be the displacement peak around t=300 in FIG. 6. This peak is relatively small in amplitude, and the slew rate (temporal rate of change of displacement) is rather low. This peak is probably small enough that compensation of the image position to remain readable is not required.

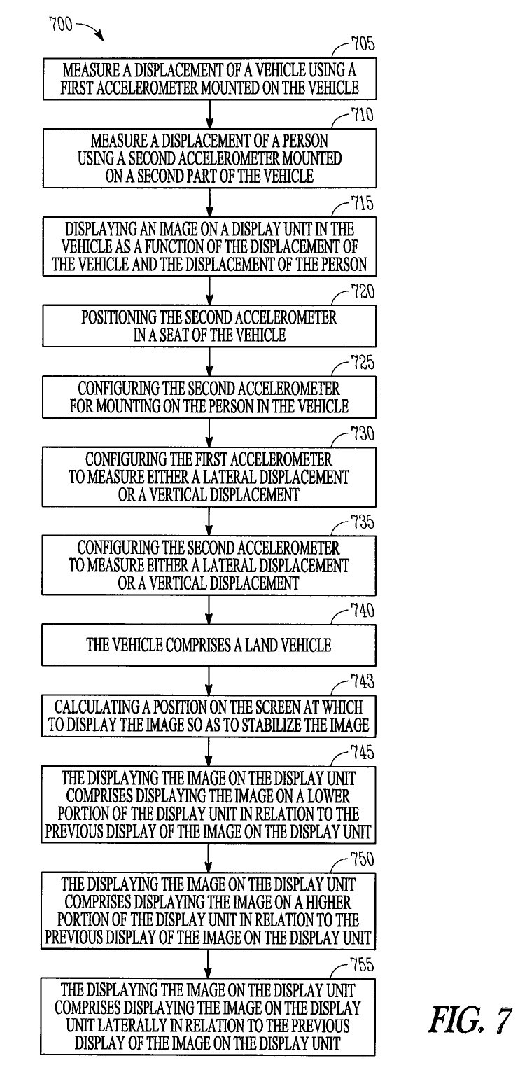

FIG. 7 is a flowchart of an example process 700 for stabilizing an image on a video display unit. FIG. 7 includes a number of process blocks 705-755. Though arranged serially in the example of FIG. 7, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

As illustrated in FIG. 7, the process 700 includes measuring a displacement of a vehicle using a first accelerometer mounted on a vehicle at 705, measuring a displacement of a person in the vehicle using a second accelerometer positioned in proximity to the person at 710, and displaying an image on a display unit in the vehicle as a function of the displacement of the vehicle and the displacement of the person at 715. At 720, the second accelerometer is positioned in a seat of the vehicle, and at 725, the second accelerometer is configured for mounting on the person in the vehicle. At 730, the first accelerometer is configured to measure either a lateral displacement or a vertical displacement, and at 735, the second accelerometer is configured to measure either a lateral displacement or a vertical displacement. As indicated at 740, the vehicle can be a land vehicle. At 743, a position on the display screen is calculated at which to display the image so that the image is stabilized. At 745, the image is displayed on a lower portion of the display unit in relation to a previous display of the image on the display unit. At 750, the image is displayed on a higher portion of the display unit in relation to a previous display of the image on the display unit. And at 755, the image is displayed shifted laterally in relation to a previous display of the image on the display unit.

Thus, an example system and method for stabilizing an image on a display unit has been described. Although specific example embodiments have been described, it will be evident that various modifications and changes may be made to these embodiments without departing from the broader scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A method comprising:
measuring a displacement of a vehicle using a first accelerometer mounted on the vehicle;
measuring a displacement of a person in the vehicle using a second accelerometer positioned in proximity to the person; and
displaying an image on a display unit in the vehicle as a function of the displacement of the vehicle and the displacement of the person.

2. The method of claim 1, wherein the second accelerometer is positioned in a seat of the vehicle.

3. The method of claim 1, wherein the second accelerometer is configured for mounting on a person in the vehicle.

4. The method of claim 1, wherein the first accelerometer is configured to measure either a lateral displacement or a vertical displacement.

5. The method of claim 1, wherein the second accelerometer is configured to measure either a lateral displacement or a vertical displacement.

6. The method of claim 1, wherein the vehicle comprises a land vehicle.

7. The method of claim 1, wherein the displaying the image on the display unit comprises displaying the image on a lower portion of the display unit in relation to a previous display of the image on the display unit.

8. The method of claim 1, wherein the displaying the image on the display unit comprises displaying the image on a higher portion of the display unit in relation to a previous display of the image on the display unit.

9. The method of claim 1, wherein the displaying the image on the display unit comprises displaying the image on the display unit shifted laterally in relation to a previous display of the image on the display unit.

10. A system comprising:
a first accelerometer;
a second accelerometer; and
a processor coupled to the first accelerometer and the second accelerometer;
wherein the processor is configured to:
receive input from the first accelerometer and the second accelerometer,
calculate a displacement of the first accelerometer and a displacement of the second accelerometer; and
refresh a video display unit as a function of the displacement of the first accelerometer and the displacement of the second accelerometer to shift a displayed image responsive to such displacements.

11. The system of claim 10, comprising the video display unit.

12. The system of claim 10, comprising a vehicle, wherein the first accelerometer and the second accelerometer are coupled to the vehicle.

13. The system of claim 12, wherein the first accelerometer is mounted on a frame of the vehicle.

14. The system of claim 12, wherein the second accelerometer is mounted in a seat in the vehicle.

15. The system of claim 10, wherein the second accelerometer is configured for mounting on a person in the vehicle.

16. A system comprising:
a first accelerometer mounted on a first portion of a vehicle;
a second accelerometer mounted on a second portion of the vehicle;
a video display unit mounted on the vehicle; and
a processor coupled to the first accelerometer, the second accelerometer, and the video display unit;
wherein the processor is configured to:
receive input from the first accelerometer and the second accelerometer,
calculate a displacement of the first accelerometer and a displacement of the second accelerometer; and
refresh the video display unit as a function of the displacement of the first accelerometer and the displacement of the second accelerometer.

17. The system of claim 16, further comprising the vehicle.

18. The system of claim 16, wherein the vehicle is a land-based vehicle.

19. The system of claim 16, wherein the second accelerometer is mounted in a seat in the vehicle.

20. The system of claim 16, wherein the second accelerometer is configured for mounting on a person in the vehicle.
